(19) United States
(12) Patent Application Publication
(10) Pub. No.: US 2011/0080284 A1
(43) Pub. Date: Apr. 7, 2011

(54) Illuminated Furniture Utilizing Solar or Wind Energy

(76) Inventor: Harry E. Nicodem, McHenry, IL (US)

(21) Appl. No.: 12/896,568

(22) Filed: Oct. 1, 2010

Related U.S. Application Data
(60) Provisional application No. 61/277,947, filed on Oct. 1, 2009.

(51) Int. Cl. G08B 21/00

(52) U.S. Cl. 340/540

(57) ABSTRACT

The present invention is a furniture apparatus that uses an indicator, such as a light, to provide a signal to a user. Power can be provided to the indicator by energy acquisition elements and energy storage elements. The energy acquisition elements and energy storage elements can be combined along with the necessary sensors and switches to allow the user to control the acquisition of energy and whether or not the indicator is activated. For convenience purposes, a carriage housing the energy acquisition elements and energy storage element can be removed from the furniture for acquiring energy in a remote location from the furniture.

### PRIORITY STATEMENT

This application claims the benefit of U.S. Provisional Application 61/277,947 filed Oct. 1, 2009.

### FIELD OF THE INVENTION

The present invention relates to a furniture apparatus that conveys information about the furniture, its surrounding environment, and its relation to the surrounding environment, without the need for an independent source of electricity, more particularly, the present invention relates to illuminated furniture which utilizes solar or wind power to generate the light.

### BACKGROUND OF THE INVENTION

Outdoor furniture is a popular way to enjoy the outdoors while enjoying some of the comforts that are traditionally found indoors. However, enjoyment of outdoor furniture can be hampered by challenges that are not generally present indoors. For example, due to low light conditions, it can be very difficult to see the furniture that is located in the back of the yard. This difficulty is not only inconvenient, it can present a danger when someone is walking outdoors because they could run into or trip over furniture that they cannot see.

Further, outdoor furniture is subject to varying temperatures. At the extremes, very hot or cold furniture is difficult to enjoy and can be dangerous. For example, a metal chair that has been baking in the afternoon sun is more than capable of burning human skin. Yet another challenge that the outdoors brings is precipitation. Furniture that has gotten wet can retain water well past the time that the precipitation stops. Naturally, a wet piece of furniture is less than ideal for use.

Even though it may not be possible to completely eliminate the challenges that the outdoors brings, their effects can be minimized if people are made aware of certain information. For example, the darkness of night can be navigated if a person knows where the furniture is; a person can avoid using furniture that is too hot or too cold if they know the furniture's temperature before they use it; and a person can dry the furniture off if they know it is wet before they use it.

While the technology exists to sense many of these conditions, their implementation is frustrated by the fact that reliable sources of electrical power are often absent in the outdoors. Further, furniture is often designed as much for its aesthetics as it is for its utility. There must be a means of conveying the sensor information without compromising the aesthetic qualities of the furniture.

For all the above reasons, there is a need for a furniture apparatus that conveys information about the furniture, its surrounding environment, and its relation to the surrounding environment, without the need for an ongoing source of electricity, such as a battery or connection to an AC outlet. The present invention attempts to satisfy these needs.

### SUMMARY OF THE INVENTION

The present invention is a piece of furniture, which is capable of signaling information about the furniture, its surrounding environment, and its relation to the surrounding environment. Such information can include the location of the furniture using illumination or sound. The present invention also includes a method for acquiring energy for use by the furniture, such as through a solar collector, a wind turbine, or through an electrical outlet.

The preferred embodiment of the present invention is a piece of furniture, such as a chair or chaise lounge, that uses an indicator, such as a light, to perform the signaling. Power can be provided to the indicator by an energy acquisition element, such as a solar collector, and stored in an energy storage element, such as a battery or capacitor. The energy acquisition element and energy storage element can be combined along with the necessary switches to allow the user to control the acquisition of energy and whether or not the indicator is activated, either by the touch of a switch, remotely or through programming. Further, for convenience purposes, the entire carriage housing the energy acquisition element and energy storage element can be removed from the piece of furniture for acquiring energy in a location remote from the furniture, such as a sunnier part of a backyard or through an indoor electrical outlet.

The energy acquisition element converts power found in the environment, such as sunlight or wind, into electrical power. This electrical power is then stored by the energy storage element until it is needed, such as when the indicator is activated at night or during other dark conditions.

Different embodiments of the invention may activate the indicator in response to different conditions. Activation of the indicator may occur when sufficient electrical power is present, a switch is moved to complete a circuit, or when a sensor or sensors read a specific value or within a range of values. Further, activation can be pre-programmed to occur at certain times, or controlled remotely through an infra-red (IR) or radio-frequency (RF) remote control.

Activating the indicator will provide information as to the location of the furniture. One possible placement scheme is placing indictor lights in the gaps of furniture that is constructed with slats. To conserve power, a low-power indicator light can be used. Further, environmentally sensitive steps can be taken such as making the furniture out of recycled plastic.

In the preferred embodiment, acrylic rod “light pipes” are securely mounted between the slats in the back rest of a chair to light up brightly at night. Multiple colored LEDS can be used to illuminate the light pipes so that a number of different colored lights can be used in the same piece of furniture. The light pipes can be laser etched to enhance visibility and direct the release of illumination light in a way that is aesthetically pleasing.

While the invention is described herein with relation to certain embodiments and applications, those with skill in this art will recognize changes, modifications, alterations and the like which still come within the spirit of the inventive concept, and such are intended to be included within the scope of the invention as expressed in the following drawings, description and claims disclosed herein.

### DESCRIPTION OF THE FIGURES

The invention can be better understood by reading the following detailed description of certain preferred embodiments, reference being made to the accompanying drawings in which:

FIGS. 1A through 1F are illustrations of the present invention in accordance with the preferred and alternative embodiments from various views;

FIG. 2 is an illustration showing a partial view of the top of a chair of an embodiment of the present invention;

FIG. 3 is an illustration showing a partial view of the inside of a slat of an embodiment of the present invention;

FIG. 4 is an illustration showing a partial view of an arm of a chair of an embodiment of the present invention; and

FIG. 5 is an illustration of an alternative embodiment of the present invention

### DETAILED DESCRIPTION

The present invention is embodied by a piece of furniture comprising an indicator, such as a light or audible alarm, and a method for acquiring and storing energy for use by the furniture to activate the indicator.

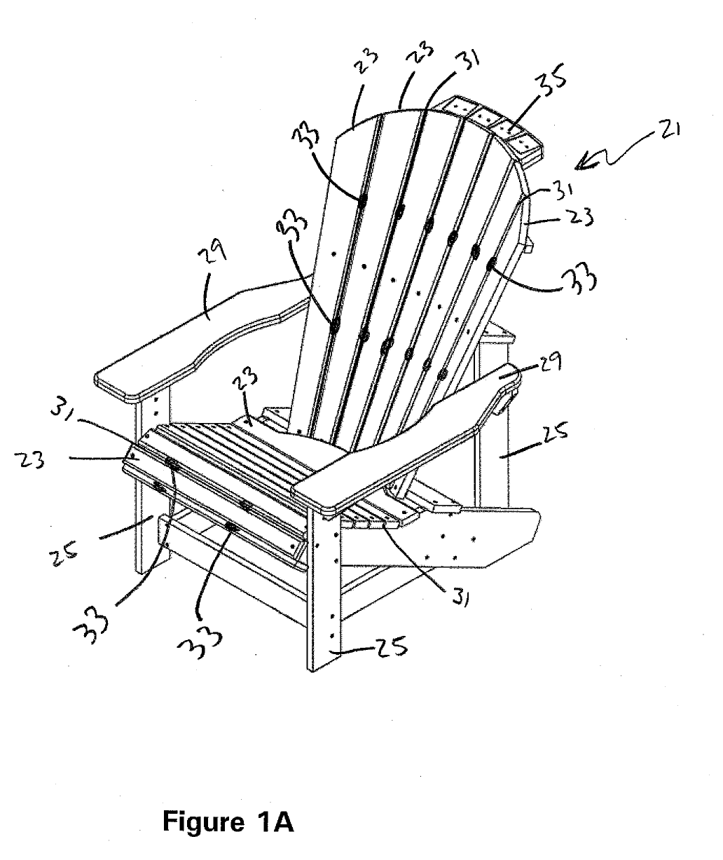

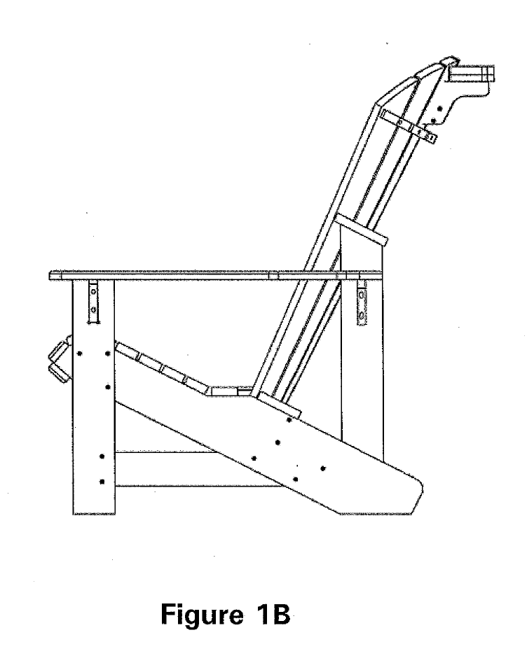

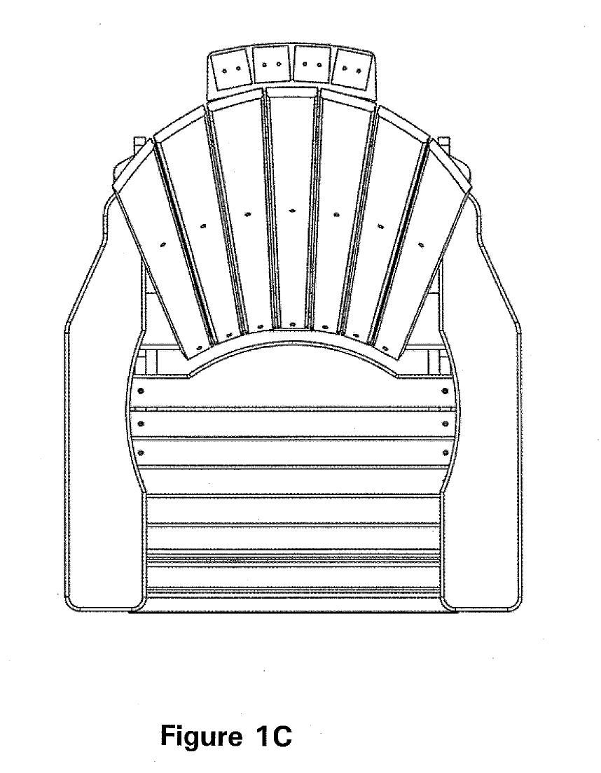

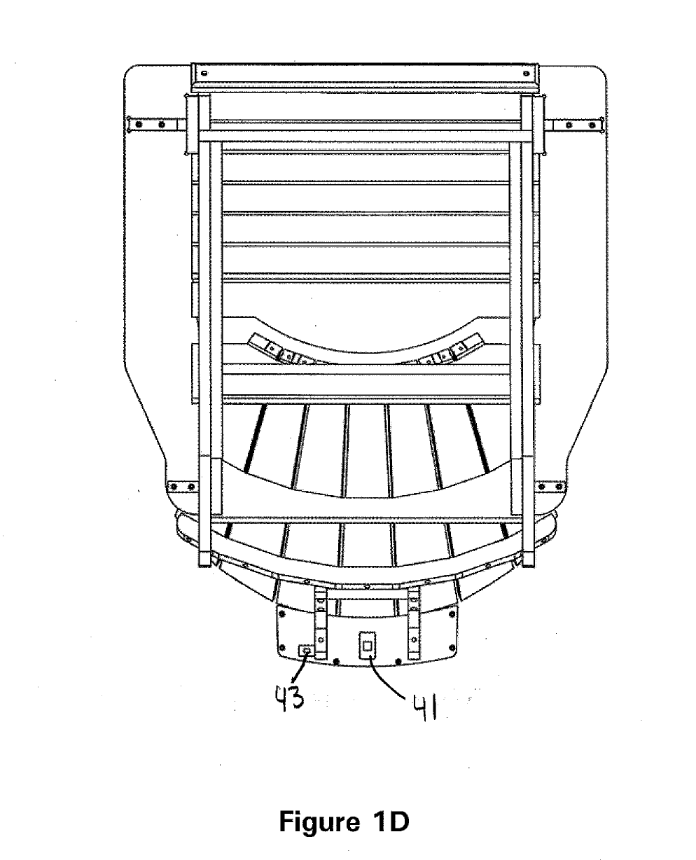

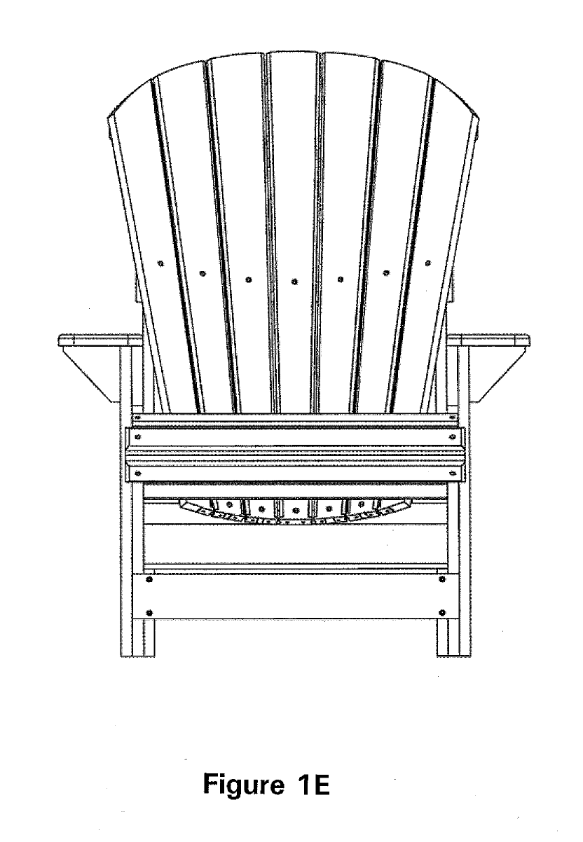

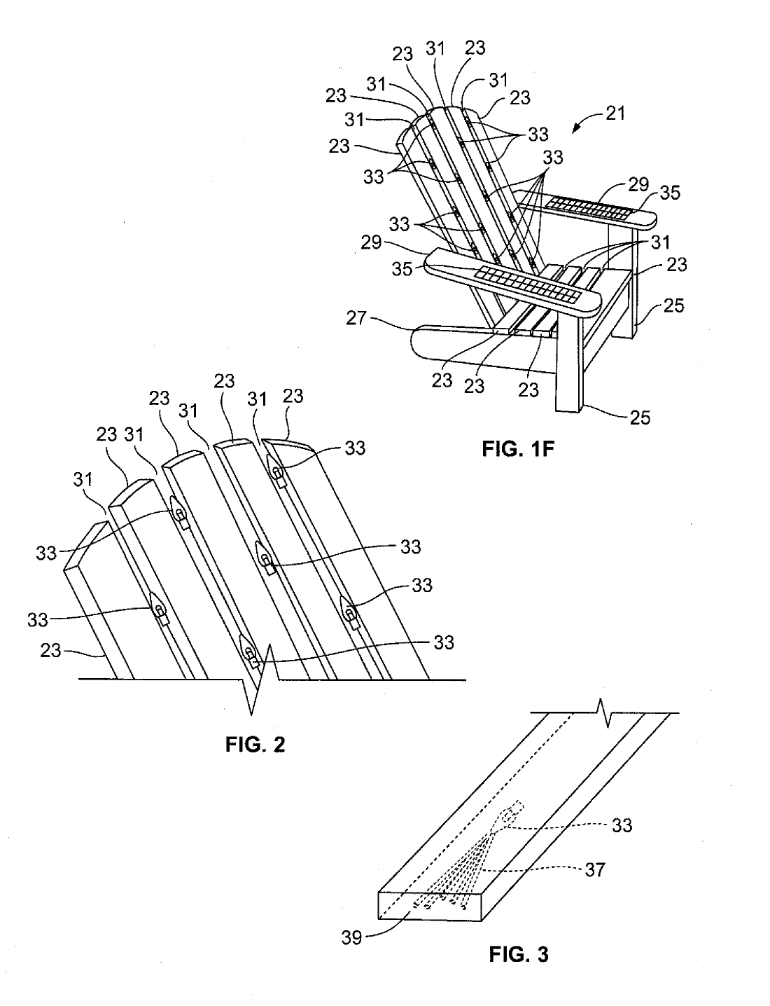

FIG. 1A shows the preferred embodiment of the present illuminated furniture invention, an illuminated chair 21. The chair 21 comprises: a series of slats 23, legs 25, arms 29. The slats are spaced apart from each other as to create a series of gaps 31, in which indicators 33 are located, in this case lights. Also, an energy acquisition element 35 is located behind the top back of the chair 21.

The illustrated chair style is commonly referred to as an Adirondack chair. However, other styles of chairs and other furniture or other pieces can be used without departing from the present invention, such as a bar, bench, lounge, swing, table, umbrella, etc.

FIGS. 1B through 1E show the same chair from different views; including side view (FIG. 1B), top view (FIG. 1C), bottom view (FIG. 1D), and back view (FIG. 1E). Further, FIG. 1F shows an alternative embodiment in which energy acquisition elements are located in or on the arms 29 or arm rests.

An exemplary list of materials that may be used in the construction of the chair 21 or other furniture piece, alone or in combination with other materials, includes, for example, wood, plastic, metal, composite materials, foams, cloth, leather, etc., or any combination thereof. A weather resistant and environmentally friendly embodiment may be made with recycled plastic. In the preferred embodiment, the slats are cut out of a single large sheet so they remain connected by a thin web across the back of the chair. This construction provides a stronger and more rigid end product.

FIG. 1A shows indicators 33 mounted in the gaps 31 between the slats 33 and energy acquisition elements 35 mounted on the back of the chair 21, but it can be placed anywhere on the furniture piece where the sun or wind can provide the necessary energy to charge, the energy acquisition element 35. Further, the energy acquisition element 35 is configured to be easily removed from the chair 21 to be placed in a better location to acquire the energy necessary to activate the indicator 33 without the need to move the chair 21 itself. In some instances, the better location will be remote from the chair 21. Also, in the preferred embodiment, the energy acquisition element 35 can be placed indoors and charged using a conventional AC charger (or DC charger) as understood by those having ordinary skill in the art.

FIG. 1F shows an alternative embodiment of the illuminated furniture invention 21 with the energy acquisition elements 35 located in or on the arms 29 of the chair 21, instead of attached to the back of the chair 21.

FIG. 2 shows the indicators 33 in relation to the gaps 31 and slats 23. In the illustrated embodiment the indicators 33 are lights 33 which illuminate the gaps 31. The light from the indicators 33 may also diffuse, to illuminate the slats 23 and/or other components. Additionally, the light from the indicators 33 may be projected on objects around the chair 21, such as the ground.

Placement of the indicators 33 between the gaps 31 is the preferred embodiment, however, the indicators 33 may be placed on any of the surfaces. Further, the indicators 33 may be placed inside the various components. For instance, FIG. 3 shows a slat section 23 with an indicator light 33 placed within it. Fiber-optic cables 37 are installed, which route the light from the indicator 33 to the slat's 23 outer edge 39. Other light piping may be used and selectively roughened or etched to release light at specific locations. Alternatively, a transparent or translucent slat 23 could be used to allow the light to diffuse through the slat 23. By carefully considering the placement of the indicators, an aesthetically pleasing arrangement can be achieved. Further, the locations of the indicators 33 are chosen so as not to interfere with any of the different uses of the furniture 21.

While almost any light may be adapted for use as an indicator 33, a preferred light is low-power in nature. Examples of such lights include light emitting diodes (LEDs), organic light emitting diodes (OLEDs), laser diodes, and florescent materials or tubes containing fluorescent gasses. Many of these lights are available in different colors and some can change between colors during operation. The selection of certain colors may also lead to aesthetic enhancements.

Indicators 33 for use in the present invention are not limited to lights. Other visual indicators 33 include, but are not limited to, electronic ink, cathode ray tubes, and liquid crystal displays. Further, indicators 33 are not limited to those that are visual in nature. For example, auditory indicators 33, such as bells, horns, speakers, and whistles may be used.

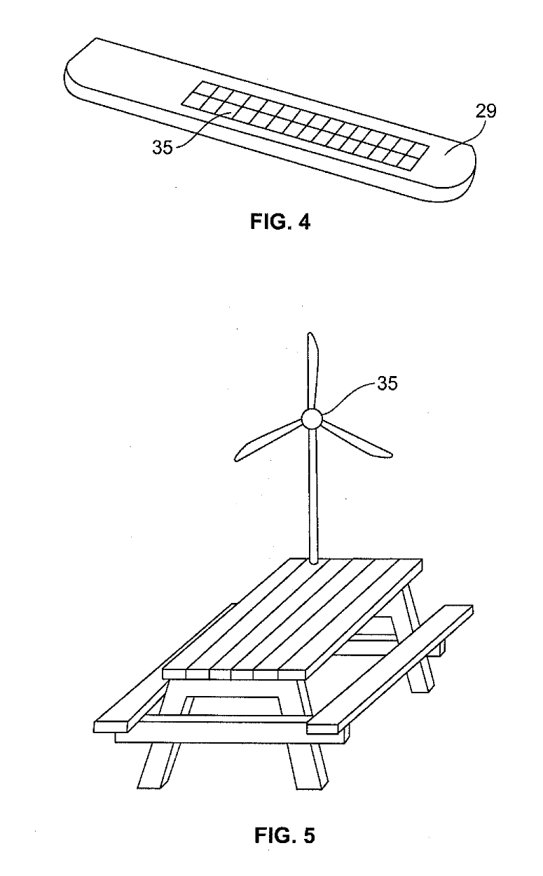

Although the preferred embodiment locates the energy acquisition elements 35 on the back of the chair 21 (FIG. 1A), FIG. 4 shows energy acquisition elements 35 on the arm 29 of the chair 21 (see also FIG. 1F). The illustrated energy acquisition element 35 is a photovoltaic module, which converts solar energy to electricity. The photovoltaic energy acquisition element 35 can be located on the chair 21 (FIG. 1) anywhere it would be exposed to sunlight, however, other energy acquisition elements may also be used. For example, FIG. 5 shows a wind turbine energy acquisition element 35 in conjunction with a furniture piece in the style of a table. Additional energy acquisition elements may include water turbines and Peltier modules.

The energy acquisition element 35, may operate in conjunction with an energy storage device (not shown), such as a rechargeable battery. The energy storage device allows power from the energy acquisition elements 35 to be stored for use at a future time. This energy storage device makes it possible for the apparatus to operate when the energy acquisition elements 35 are not working (e.g. a photovoltaic panel at night).

The preferred embodiment of the present invention may further include a sensor 41 (FIG. 1D) and supporting components (not shown). The sensor 41 allows the apparatus to be aware of specific conditions or changes in the furniture, the furniture's surrounding environment, and/or the furniture's relationship to its environment.

For example a photosensor could be used to detect the presence of light to turn off the indicator 33 during daylight hours, a motion sensor could be used to detect the presence of motion or of someone approaching the furniture, a load-cell could be used to detect that a user is seated in the chair and a thermometer could be used to find the temperature of the furniture or its surrounding environment. The sensors or their surrounding components can be configured with thresholds that turn the indicators on and off. Further the sensor may be made to act differently at different thresholds in order to convey information that is more than binary in nature.

In the preferred embodiment, the present invention employs solar power and a replaceable, rechargeable battery (not shown) to conserve resources, along with smart microprocessor (not shown) power management and control for maximum battery life. In use, the lights can turn on at nightfall and turn off automatically after four hours runtime, although the time on and/or off can be user extendable and programmable. Further, the preferred embodiment can delay the illumination for at least five minutes (of darkness) before the lights illuminate.

The functions, such as color and timing, can be controlled by a proximity sensor switch, although any switch 43 can be utilized. In the preferred embodiment, the proximity sensor switch is a transmitter and receiver placed in the carriage that houses the energy acquisition element 35. These elements can be positioned such that the user merely places his or her hand over the two elements to indicate a change in state, such as on/off, different color light, or different runtime. The receiver “picks up” the transmitted signal that has been reflected off of the user's hand in order to function.

In order to avoid a brash neon sign look the lights use a soothing, slow fade in and fade out brightness control.

In operation, the energy acquisition elements 35 convert energy from the environment into electricity. This electricity is either expended immediately or is stored in the energy storage device, such as a battery. The indicator 33 can be always on or can be activated by a sensor 41. When activated the indicator 33 conveys the necessary information. For example, the indicator 33 may be designed to show location information. This information could be valuable in low light conditions, such as outdoors at night, where it may be difficult to otherwise see the furniture 21. The indicator 33 could be always on, or a switch (not shown) could be used to selectively activate the indicator.

However, the indicator 33 could also turn on and off based on environmental conditions. For example, the indicator 33 could be activated based on the amount of light, the presence of motion, the proximity of motion, or any combination thereof. Further different indicators may activate or the behavior of an indicator may be different based on the environmental conditions. For example the intensity with which an indicator light glows may be changed based on the light in the environment.

In the preferred embodiment, the chair 21 is placed in position, for example, on a lawn or patio deck. The user turns on the power switch 43, located under the carriage. As described above, the preferred embodiment utilizes a proximity sensor 41 for turning the device on and off, changing the colors of the illumination and changing the runtime of the device, among other functions.

The chair 21 can be illuminated in numerous colors, such as red, green, blue, yellow, magenta, aqua, and white. Further, the device may be set to cycle through some or all of these colors. Any one of these colors can be selected for illumination by using the proximity sensor switch, or another type of switch.

In the preferred embodiment, to use the proximity sensor 41, the user holds his or her hand against the rear of the carriage near the sensor 41 until the lights flash three times in the color desired, upon which the user removes the hand from proximity to the sensor 41.

Also, as an example of extending the runtime after the chair turns itself off (after four hours), the user employs the proximity sensor 41 and the lights illuminate again after a few seconds to stay on for another hour. This method allows for the chair 21 to be illuminated for most of the useable night time, with the option of increasing the time, and still provides a shut off for conserving battery life.

The chair 21 can be programmed to flash several times to indicate low battery power, either during operation or when the power switch is turned on.

As described above, if the chair 21 and carriage containing the energy acquisition elements 35 are located in a sunny location, the chair 21 should recharge, each day making the use of indoor charging unnecessary. However, if the chair 21 is in a shaded location, the energy acquisition elements 35 can be periodically removed and placed in a sunny location, or brought indoors and recharged using an AC or DC charger. Several days of cloudy weather may result in a low battery indication necessitating indoor charging.

In one embodiment, to remove the energy acquisition elements 35 or carriage, the lighting cable is first carefully unplugged from under the carriage. The plug is similar to that used for telephone cables so that by pressing the locking tab, the connector can be pulled out of the carriage. Of course, there are numerous types of connectors that can be used in this system. Once the lighting connector has been removed from the carriage, the carriage will slide off of its mount on the back of the chair. Now the carriage can be placed in the sunlight location, or brought in to be charged.

In the preferred embodiment, the carriage 35 is detachably mounted to the back of the chair with integral spring pin contacts. This allows the carriage 35 to make electrical contact with the lighting elements without requiring the user to unplug a lighting cable when the carriage 35 is removed. The detachable mounting scheme in the preferred embodiment employs magnets and shaped surfaces to maintain electrical contact with the lighting elements 33 and to ensure that spring pins on the carriage 35 are guided consistently onto the counter-part spring pin targets.

Another example of an indicator 33 operation is a furniture item that activates a red indicator light when the furniture has exceeded a certain high temperature threshold and displays a blue light when it has exceeded a certain low temperature threshold.

Another example of the use of the indicator 33 functionality on the furniture of the present inventions is the use of a receiver/transmitter or wireless link between numerous pieces of furniture 21 in a group. For example, a group of chairs 21 could be linked together via wireless technologies to display synchronized patterns or to respond individually or in a group to an external stimulus such as music. These patterns can be useful for mere decoration or more functional as to direct the flow of pedestrians in a certain direction, such as to signal available seating at a restaurant or at a pool side. The furniture 21 can also be useful for directing individuals during an emergency or in a dark environment such as a darkened movie theater.

The pool side could also be an example of a decorative use, where hundreds of chaise lounges 21 at a hotel pool can be illuminated different colors at night to enhance the view of the pool from the rooms. The colors can be synchronized with the colors of the other chaise lounges, or the colors can be random.

Although the present invention has been described in considerable detail with reference to certain preferred versions thereof, other versions are possible. Therefore, the spirit and scope of the appended claims should not be limited to the description of the preferred embodiment described herein.

What is claimed is:

1. A furniture apparatus with an indicator, comprising:
an energy capture element;
an energy storage element connected to said energy capture element configured to allow energy to be stored in the energy capture element;
an indicator attached to said furniture apparatus and connected to the energy storage element, such that the indicator can be activated based on environmental conditions;
wherein said energy capture element and said energy storage element are removeably attached to said furniture apparatus and said indicator such that said energy storage element can receive energy after it is removed from said furniture apparatus.

2. The furniture apparatus of claim 1, where the indicator is connected to the energy storage element though a sensor, said sensor being capable of controlling energy from the energy storage element to the indicator.

3. The furniture apparatus of claim 2, wherein the furniture apparatus is a chair.

4. The furniture apparatus of claim 2, wherein the indicator is a light.

5. The furniture apparatus of claim 1, wherein the environmental conditions is darkness.

6. The furniture apparatus of claim 2, wherein the sensor controls the illumination of the light for a specified amount of time.

7. The furniture apparatus of claim 3, wherein a plurality of chairs are connected together through a wireless network.

8. The furniture apparatus of claim 7, wherein said plurality of chairs are connected together through a wireless network to direct individuals in a specific direction.

9. The furniture apparatus of claim 8, wherein said plurality of chairs are connected together through a wireless network to respond to music, either as a group or individually.

10. The furniture apparatus of claim 1, wherein said energy capture element can be removed from said furniture apparatus to capture energy at a location remote from said furniture apparatus.

11. The furniture apparatus of claim 1, wherein said sensor utilizes a receiver and transmitter thereby controlling said indicator by proximity activation and not actual contact with the sensor.
